(19) United States
(12) Patent Application Publication
(10) Pub. No.: US 2023/0326311 A1
(43) Pub. Date: Oct. 12, 2023

(54) WIRELESS SYSTEM, TERMINAL APPARATUS, BASE STATION, WIRELESS TRANSMISSION METHOD, AND WIRELESS TRANSMISSION PROGRAM

(71) Applicant: NIPPON TELEGRAPH AND TELEPHONE CORPORATION, Tokyo (JP)

(72) Inventors: Mitsuki NAKAMURA, Musashino-shi, Tokyo (JP); Wataru YAMADA, Musashino-shi, Tokyo (JP); Yasuhiko INOUE, Musashino-shi, Tokyo (JP); Shoko SHINOHARA, Musashino-shi, Tokyo (JP); Yusuke ASAI, Musashino-shi, Tokyo (JP); Yasushi TAKATORI, Musashino-shi, Tokyo (JP)

(73) Assignee: NIPPON TELEGRAPH AND TELEPHONE CORPORATION, Tokyo (JP)

(21) Appl. No.: 18/022,306

(22) PCT Filed: Aug. 25, 2020
(86) PCT No.: PCT/JP2020/032019

§ 371 Date: Feb. 21, 2023

(51) Int. Cl. G08B 13/196

(52) U.S. Cl. CPC G08B 13/1966; G08B 13/19608

(57) ABSTRACT

A wireless system according to an embodiment includes at least one terminal and a base station. The terminal includes a wireless communication module and a first control unit. The wireless communication module transmits and receives data to and from the base station. When motion is detected from an acquired video, the first control unit transmits a frame image, which is a still image extracted from the video, to the base station by using the wireless communication module, and transmits the video to the base station by using the wireless communication module when transmission of the video is requested by the base station as a result of transmitting the frame image. The base station includes a second control unit. The second control unit determines whether or not to request transmission of a video on the basis of a frame image, and requests a terminal to transmit a video when determining to request transmission of a video.

### TECHNICAL FIELD

An embodiment relates to a wireless system, a terminal, a base station, a wireless communication method, and a wireless communication program.

### BACKGROUND ART

The communication standard IEEE 802.11ah is a communication standard for IoT (Internet of Things). One of the applications of the terminal compliant with IEEE 802.11ah assumes the transmission of a video captured by a camera installed outside the home or in a remote place. Such a camera constantly photographs and acquires videos. Therefore, if all of the videos captured by the camera are to be transmitted, the transmission capacity is expected to be enormous.

### CITATION LIST

### Patent Literature

[PTL 1] Japanese Patent Application Publication 2017-85201

### SUMMARY OF INVENTION

### Technical Problem

An embodiment provides a wireless system, a terminal, a base station, a wireless transmission method, and a wireless transmission program that are suitable for transmission of videos.

### Solution to Problem

A wireless system according to an embodiment includes at least one terminal and a base station. The terminal includes a wireless communication module and a first control unit. The wireless communication module transmits and receives data to and from the base station. When motion is detected from an acquired video, the first control unit transmits a frame image, which is a still image extracted from the video, to the base station by using the wireless communication module, and transmits the video to the base station by using the wireless communication module when transmission of the video is requested by the base station as a result of transmitting the frame image. The base station includes a second control unit. The second control unit determines whether or not to request transmission of the video, on the basis of the frame image, and requests transmission of the video to the terminal when determining that transmission of the video is requested.

### Advantageous Effects of Invention

According to an embodiment, a wireless system, a terminal, a base station, a wireless transmission method, and a wireless transmission program that are suitable for transmission of a video can be provided.

### BRIEF DESCRIPTION OF DRAWINGS

FIG. 1 is a diagram showing an example of a configuration of a wireless system according to an embodiment.

FIG. 2 is a diagram showing an example of a configuration of a terminal.

FIG. 3 is a diagram showing an example of a configuration of a base station.

FIG. 4 is a diagram showing an example of a functional configuration of the terminal.

FIG. 5 is a diagram showing an example of a functional configuration of the base station.

FIG. 6 is a flowchart for explaining an operation of the terminal.

FIG. 7 is a flowchart for explaining an operation of the base station.

FIG. 8 is a diagram showing an example of a functional configuration of a terminal according to a modification.

### DESCRIPTION OF EMBODIMENTS

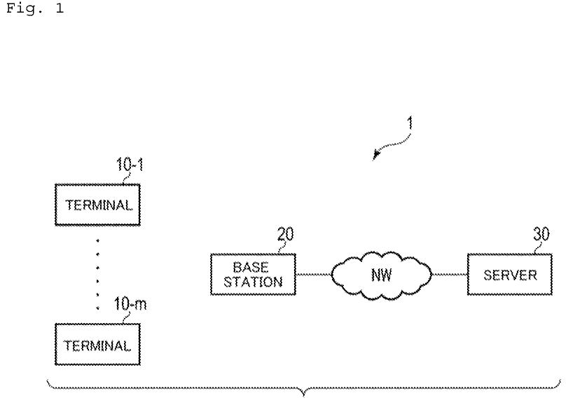

An embodiment will be described hereinafter with reference to the drawings. FIG. 1 illustrates an example of a configuration of a wireless system 1 according to the embodiment. As shown in FIG. 1, a wireless system 1 includes, for example, a terminal 10, a base station 20, and a server 30.

Terminals 10-1 to 10-m are m (m is a natural number) terminals with cameras. Each of the terminals 10-1 to 10m photographs the inside of an angle of view. Each of the terminals 10-1 to 10-m includes a wireless communication device, and transmits an image acquired as a result of photographing, to the server 30 on a network NW via the base station 20. The images transmitted from the terminals 10-1 to 10-m include videos filmed by the respective terminals and frame images which are still images extracted from the videos. Communication between the terminals 10-1 to 10-m and the base station 30 is based on, for example, the IEEE 802.11 standard. Here, the number of cameras provided in one terminal may be one or two or more. A plurality of the cameras may be configured to photograph within different angles of view or may be configured to photograph within the same angle of view. The terminals 10-1 to 10-m may each also be a separate body from its camera. When the terminal and the cameras are separate bodies, different terminals may be connected to each of the plurality of cameras, or one terminal may be connected to the plurality of cameras.

The base station 20 is a wireless communication device connected to the network NW and used as an access point for a wireless LAN. For example, the base station 20 transmits videos or frame images received from the terminals 10-1 to 10-m to the server 30 via the network NW.

The server 30 holds various data transmitted from the base station 20. The data transmitted from the base station 20 can be utilized for various types of processing. For example, when videos acquired by the terminals 10-1 to 10-m are sent from the base station 20, the videos can be used for various types of analysis processing. The server 30 is connected to, for example, the network NW by wire, and is configured to be able to communicate with the base station 20 via the network NW. It is sufficient for the server 30 to be capable of communication with at least the base station 20. That is, communication between the base station 20 and the server 30 may be by wire or wireless.

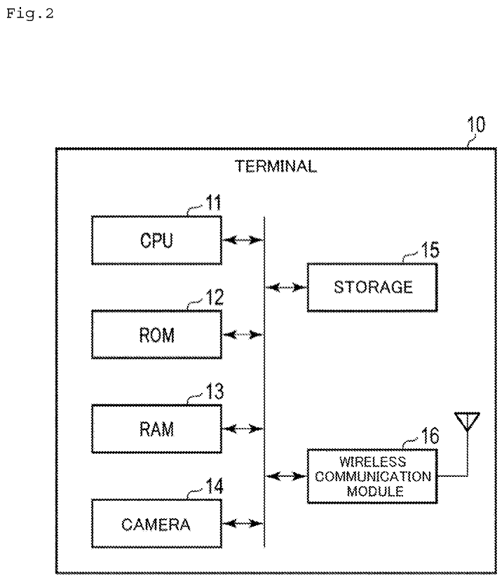

FIG. 2 shows an example of a configuration of a terminal 10, one of the terminals 10-1 to 10-m. As shown in FIG. 2, the terminal 10 includes, for example, a CPU (Central Processing Unit) 11, a ROM (Read Only Memory) 12, a RAM (Random Access Memory) 13, a camera 14, a storage 15, and a wireless communication module 16.

The CPU 11 is a circuit capable of executing various programs, and controls an overall operation of the terminal 10. An ASIC or the like may be used instead of the CPU. Also, the number of CPUs 11 is not limited to one; there may be two or more CPUs 11.

The ROM 22 is a non-volatile semiconductor memory, and holds a program, control data, and the like for controlling the terminal 10.

The RAM 13 is, for example, a volatile semiconductor memory and is used as a work area of the CPU 11.

The camera 14 has a lens and an image sensor, and films the inside of an angle of view to acquire a video within the angle of view. The lens is an optical system for collecting light within the angle of view to the image sensor. The image sensor is an image sensor such as a CCD (Charge Coupled Device) image sensor or a CMOS (Complementary Metal Oxide Semiconductor) image sensor. The image sensor receives light from a subject within the angle of view to generate image data.

The storage 15 is a nonvolatile storage device such as a flash memory, and holds system software and the like of the terminal 10. The storage 15 holds data of a video acquired through the camera 14 or data of a still image extracted from the data of the video.

The wireless communication module 16 is a circuit used for transmitting and receiving data by a wireless signal, and is connected to an antenna. The wireless communication module 16 includes a plurality of wireless devices that differ in, for example, at least communication path, channel, or data compression rate.

The wireless system 1 executes data communication on the basis of, for example, the OSI (Open Systems Interconnection) reference model. Communication functions in the OSI reference model are divided into seven layers (first layer: physical layer, second layer: data link layer, third layer: network layer, fourth layer: transport layer, fifth layer: session layer, sixth layer: presentation layer, and seventh layer: application layer). The data link layer includes, for example, an LLC (Logical Link Control) layer and a MAC (Media Access Control) layer.

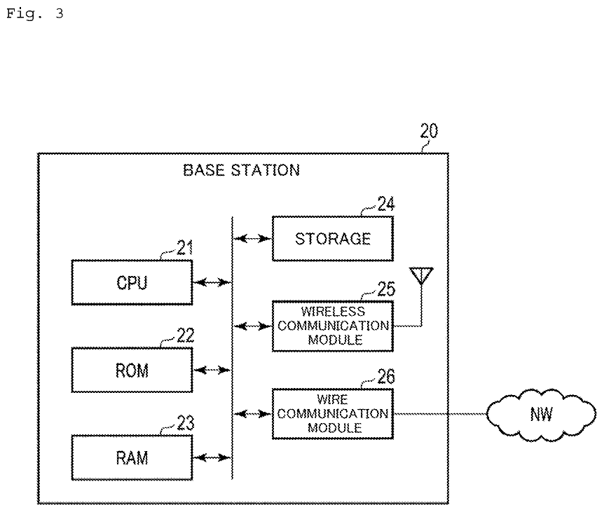

FIG. 3 shows an example of a configuration of the base station 20. As shown in FIG. 3, the base station 20 includes, for example, a CPU 21, a ROM 22, a RAM 23, a storage 24, a wireless communication module 25, and a wire communication module 26.

The CPU 11 is a processor capable of executing various programs, and controls an overall operation of the base station 20. An ASIC or the like may be used instead of the CPU. Also, the number of CPUs 11 is not limited to one; there may be two or more CPUs 11.

The ROM 22 is a non-volatile semiconductor memory, and holds a program, control data, and the like for controlling the base station 20.

The RAM 23 is, for example, a volatile semiconductor memory and is used as a work area of the CPU 21.

The storage 24 is a nonvolatile storage device such as a flash memory, and holds system software and the like of the base station 20. The storage 24 holds information on priority of the terminals 10-1 to 10-m. The storage 24 holds frame images which are data of videos transmitted from the terminals 10-1 to 10-m or data of still images extracted from the data of the videos.

The wireless communication module 25 is a circuit used for transmitting and receiving data by a wireless signal, and is connected to an antenna. The wireless communication module 25 includes, for example, a plurality of wireless devices corresponding to a plurality of channels.

The wire communication module 26 is a circuit used for transmitting and receiving data by a wired signal, and is connected to the network NW.

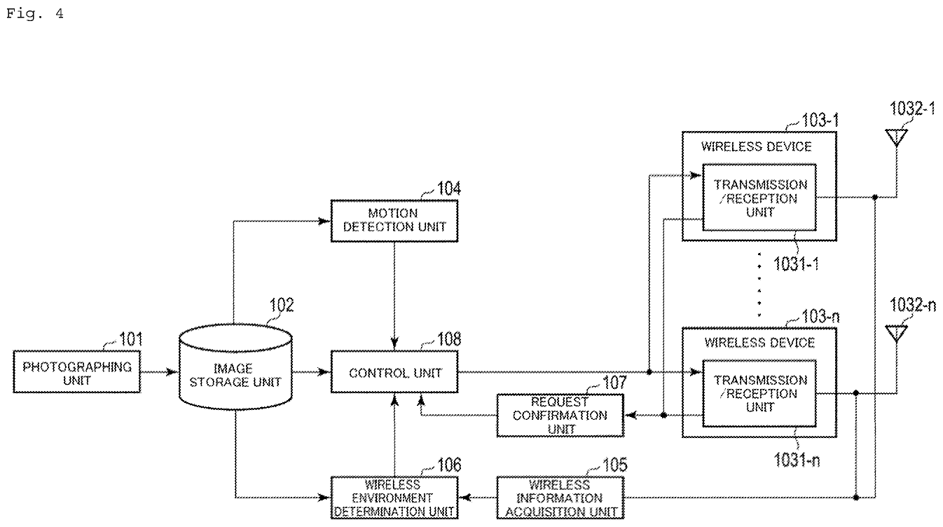

FIG. 4 is a diagram showing an example of a functional configuration of the terminal 10. As shown in FIG. 4, the terminal 10 includes a photographing unit 101, an image storage unit 102, wireless devices 103-1 to 103-n, a motion detection unit 104, a wireless information acquisition unit 105, a wireless environment determination unit 106, a request confirmation unit 107, and a control unit 108. The photographing unit 101 corresponds to the camera 14. The image storage unit 102 corresponds to the storage 15. The wireless devices 103-1 to 103-n correspond to the wireless communication module 16. The motion detection unit 104, the wireless information acquisition unit 105, the wireless environment determination unit 106, the request confirmation unit 107, and the control unit 108, are implemented by, for example, the CPU 11 executing a wireless transmission program stored in the storage 15. The motion detection unit 104, the wireless information acquisition unit 105, the wireless environment determination unit 106, the request confirmation unit 107, and the control unit 108 may be implemented by dedicated hardware for implements equivalent operations.

The photographing unit 101 performs photographing within the angle of view at a predetermined frame rate, to acquire a video composed of a plurality of frame images. Then, the photographing unit 101 stores a video acquired a fixed time prior to the latest frame image, in the image storage unit 102. The fixed time can be appropriately set in accordance with the capacity or the like of the image storage unit 102. The photographing unit 101 also stores the latest frame image in the image storage unit 102 separately from the video. The photographing unit 101 may store not only the latest frame image but also frame images up to the fixed time, in the image storage unit 102. The photographing unit 101 may compress the data of the frame images and of the video and store them in the image storage unit 102.

The image storage unit 102 stores the video acquired by the photographing unit 101 and a frame image extracted from the video.

The wireless devices 103-1 to 103-n are n (n is a natural number) wireless devices that perform processing related to transmission and reception of wireless signals. When n is 2 or higher, the wireless devices 103-1 to 103-n differ in at least communication path, use channel, or data compression rate. For example, when the wireless device 103-1 is configured to handle a wireless signal in a 2.4 GHz band, the wireless device 103-n may be configured to handle a wireless signal in a 5 GHz band. The wireless devices 103-1 to 103-n include transmission/reception units 1031-1 to 1031-n and antennas 1032-1 to 1032-n. When transmitting wireless signals, the transmission/reception units 1031-1 to 1031-n perform, for example, perform the second layer (data link layer) processing on data input from the control unit 108, to generate MAC frames. Then, the transmission/reception units 1031-1 to 1031-n perform the first layer (physical layer) processing on the MAC frames to generate wireless signals, and transmit the wireless signals to the base station 20 via the antennas 1032-1 to 1032-n. When receiving wireless signals, the transmission/reception units 1031-1 to 1031-n perform the first layer processing on the wireless signals received from the base station 20 via the antennas 1032-1 to 1032-n, to restore the MAC frames. Then, the transmission/reception units 1031-1 to 1031-n perform the second layer processing on the MAC frames to restore the data. The antennas 1032-1 to 1032-n are antennas provided with antenna elements for transmitting and receiving wireless signals. The antennas 1032-1 to 1032-n may each be configured from a single antenna element or a plurality of antenna elements. In FIG. 4, the antennas 1032-1 to 1032-n are provided separately with respect to each wireless device. On the other hand, only one of the antennas 1032-1 to 1032-n may be provided and shared by the n wireless devices.

The motion detection unit 104 detects motion from a video. For example, the motion detection unit 104 acquires a video stored in the image storage unit 102, and detects motion by calculating a motion vector representing a change between frame images constituting the acquired video. Upon detection of motion, the motion detection unit 104 notifies the control unit 108 of the detection. The method for detecting motion is not limited to a method using a motion vector. Any method can be used as the method for detecting motion. When the camera is a separate body from the terminal 10, motion may not be detected by the terminal but by the camera.

The wireless information acquisition unit 105 acquires wireless information related to a wireless environment of each of the wireless devices 103-1 to 103-n. The wireless information may include an identifier of each wireless device, a reception level of each wireless device, a delay time in each wireless device, and a throughput of each wireless device. The reception level may be measured from, for example, the reception level of a wireless signal received at a corresponding transmission/reception unit. The wireless signal may be a beacon signal or the like from the base station 20. The delay time is measured from, for example, the time from the transmission of a wireless signal by the corresponding transmission/reception unit to the reception of an acknowledge (ACK). The throughput of each wireless device can be measured from the reception level or the like.

The wireless environment determination unit 106 determines the wireless environment of each wireless device on the basis of the capacity of the video data stored in the image storage unit 102 and the wireless information acquired by the wireless information acquisition unit 105. Then, the wireless environment determination unit 106 outputs the result of determination of the wireless environment to the control unit 108. The wireless environment in the embodiment includes a transmission capacity of each wireless device at the time of determination.

The request confirmation unit 107 confirms the presence/absence of a request for a video transmitted from the base station 20 via the transmission/reception units 1031-1 to 1031-n. When there is a request for a video, the request confirmation unit 107 notifies the control unit 108 of the request.

The control unit 108 selects a wireless device suitable for transmission of a frame image according to the result of determination by the wireless environment determination unit 106. Then, the control unit 108 outputs a frame image stored in the image storage unit 102 to a selected wireless device, and transmits the frame image. After transmitting the frame image, the control unit 108 also selects a wireless device satisfying a traffic allowance notified together with a request for transmission of a video from the base station 20. Then, the control unit 108 outputs a video stored in the image storage unit 102 to the selected wireless device, and transmits the video.

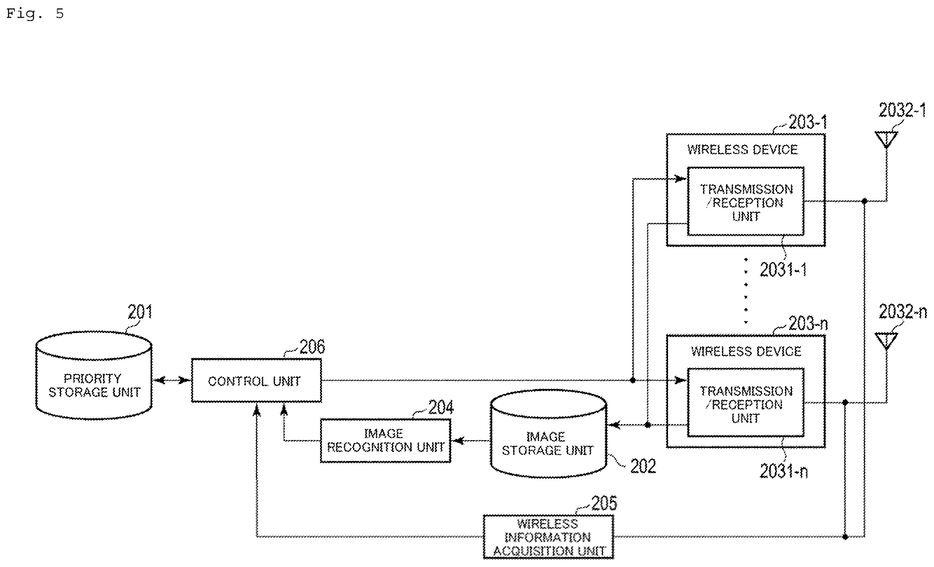

FIG. 5 is a diagram showing an example of a functional configuration of the base station 20. The base station 20 includes a priority storage unit 201, an image storage unit 202, wireless devices 203-1 to 203-n, an image recognition unit 204, a wireless information acquisition unit 205, and a control unit 206. The priority storage unit 201 and the image storage unit 202 correspond to the storage 24. The wireless devices 203-1 to 203-n each correspond to the wireless communication module 25. The image recognition unit 204, the wireless information acquisition unit 205, and the control unit 206 are implemented by, for example, the CPU 21 executing a wireless transmission program stored in the storage 24. The image recognition unit 204, the wireless information acquisition unit 205, and the control unit 206 may be implemented by dedicated hardware for performing equivalent operations.

The priority storage unit 201 stores a priority for requesting transmission of a video. The priority may be set according to, for example, the type of motion. For example, when the wireless system 1 is applied to a bird/animal detection system for bird/animal traps, the priority when the type of motion is a bird or animal may be set higher than the priority when the motion is a person or the like. In addition, the priority may be set depending on the location or the like where the terminal 10 is installed. The priority may be fixed or changed later.

The image storage unit 202 stores videos and frame images transmitted from the terminal 10. The priority storage unit 201 may be configured in a storage different from the image storage unit 202.

The wireless devices 203-1 to 203-n are n (n is a natural number) wireless devices that perform processing related to transmission and reception of wireless signals. The wireless devices 203-1 to 203-n include transmission/reception units 2031-1 to 2031-n and antennas 2032-1 to 2032-n. When transmitting wireless signals, the transmission/reception units 2031-1 to 2031-n perform, for example, perform the second layer (data link layer) processing on data input from the control unit 206, to generate MAC frames. Then, the transmission/reception units 2031-1 to 2031-n perform the first layer (physical layer) processing on the MAC frames to generate wireless signals, and transmit the wireless signals to the terminal 10 via the antennas 2032-1 to 2032-n. When receiving wireless signals, the transmission/reception units 2031-1 to 2031-n perform the first layer processing on the wireless signals received from the terminal 10 via the antennas 2032-1 to 2032-n, to restore the MAC frames. Then, the transmission/reception units 2031-1 to 2031-n perform the second layer processing on the MAC frames to restore the data. The antennas 2032-1 to 2032-n are antennas provided with antenna elements for transmitting and receiving wireless signals. The antennas 2032-1 to 2032-n may each be configured from a single antenna element or a plurality of antenna elements. In FIG. 5, the antennas 2032-1 to 2032-n are provided separately with respect to each wireless device. On the other hand, only one of the antennas 2032-1 to 2032-n may be provided and shared by the n wireless devices.

The image recognition unit 204 recognizes a subject in a frame image transmitted from the terminal 10. As a method of image recognition by the image recognition unit 204, for example, template matching is used. The method of recognition by the image recognition unit 204 is not limited to a specific method.

The wireless information acquisition unit 205 acquires wireless information of the terminal 10. The wireless information includes an identifier of the terminal 10, a usage of a channel used in communication with the terminal 10, a reception signal strength (RSSI), and a throughput. The usage of the channel may be measured from, for example, the communication time of the communication carried out with respective terminals relative to the maximum possible communication time defined between the base station 20 and the terminal 10. The RSSI represents the reception intensity of a wireless signal received by the transmission/reception unit. The RSSI is measured from, for example, the reception intensity of a response signal from the terminal 10 to a beacon signal broadcasted and transmitted from the base station 20. The RSSI used as the wireless information may be a statistical value such as a median value or a minimum value within a predetermined period. The throughput may be calculated from, for example, the RSSI.

The control unit 206 determines a terminal for requesting a video from, on the basis of the priority stored in the priority storage unit 201, the determination result of the image recognition unit 204, and the wireless information acquired by the wireless information acquisition unit 205. Then, the control unit 206 requests transmission of a video by using the wireless devices 203-1 to 203-n on the basis of the determination result. For example, when the priority of the subject photographed in a frame image is high, the control unit 206 determines to send a request for a video to a terminal that has transmitted the frame image, and requests the terminal to transmit the video. When requesting transmission of the video, the control unit 206 calculates a traffic allowance in the selected terminal, from the usage of the channel and the RSSI. For example, a terminal compliant with the IEEE 802.11ah standard has a limit on transmission time called the duty ratio 10% rule. The duty ratio 10% rule is a rule that determines that each transmission needs to be performed within 10% of the entire communicable time. The traffic allowance may be calculated on the basis of a time within 10% of the entire communicable time. The control unit 206 then determines whether communication with the selected terminal 10 can be performed or not on the basis of the current traffic allowance. The control unit 206 then waits to request transmission of the video until communication with the selected terminal 10 becomes possible. When there exist a plurality of terminals 10 capable of photographing the same angle of view as the received frame image, the control unit 206 determines to send a request for a video to the terminal 10 having a wireless device capable of transmitting a video of low quality, that is, a high data compression rate, but at a higher speed. When it is necessary to request a high-quality video such as when a subject photographed in a received frame image is small, the control unit 206 determines to send a request for the video to the terminal 10 having a wireless device capable of transmitting a video of high quality, that is, a low data compression rate, but at a slower speed. Here, when it is determined, from the video transmitted from the terminal 10 and the wireless information collected from the terminal 10, that the current wireless environment is close to a static environment with a small temporal change, a terminal for requesting transmission of a video from may be selected only from the latest wireless information. On the other hand, if it is determined that the current wireless environment is close to a dynamic environment having a large temporal change, a terminal for requesting transmission of a video from may be selected from wireless information having a relatively long time.

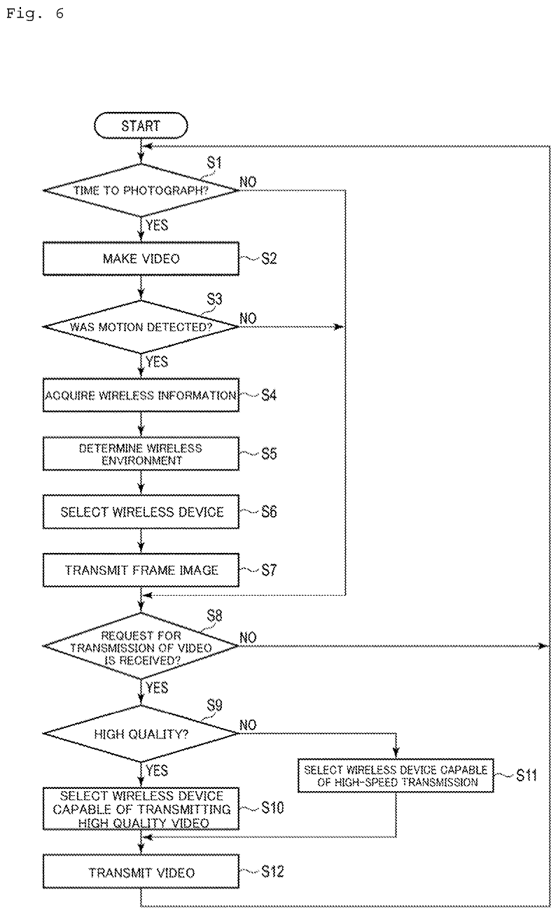

An operation of the wireless system 1 according to the embodiment will be described hereinafter. First, an operation of the terminal 10 will be described. FIG. 6 is a flowchart for explaining the operation of the terminal 10. In step S1, the photographing unit 101 determines whether it is time to take a video. In step S1, it is determined whether or not photographing timing is reached according to a predetermined frame rate. If it is determined in step S1 that it is time to take a video, the processing moves to step S2. If it is determined in step S1 that it is not the time to take a video, the processing moves to step S8.

In step S2, the photographing unit 101 photographs an image within an angle of view. Then, the photographing unit 101 stores the latest frame image obtained by photographing and a video up to a fixed time including the latest frame image, in the image storage unit 102.

In step S3, the motion detection unit 104 determines whether or not motion is detected in the video. When it is determined in step S3 that motion has been detected, the processing moves to step S4. When it is determined in step S3 that motion has not been detected, the processing moves to step S8.

In step S4, the wireless information acquisition unit 105 acquires wireless information of each of the wireless devices 103-1 to 103-n. As described above, the wireless information may include an identifier of each wireless device, a reception level of each wireless device, a delay time of each wireless device, and a throughput of each wireless device.

In step S5, the wireless environment determination unit 106 determines the wireless environment of each of the wireless devices 103-1 to 103-n based on the wireless information. As described above, the wireless environment includes the transmission capacity of each of the wireless devices 103-1 to 103-n.

In step S6, the control unit 108 selects a wireless device to be used for transmission of a frame image, on the basis of the wireless environments of the wireless devices 103-1 to 103-n determined by the wireless environment determination unit 106. The control unit 108 selects, a wireless device having, for example, the largest transmission capacity.

In step S7, the control unit 108 acquires a frame image from the image storage unit 102. Then, the control unit 108 transmits the frame image by using the selected wireless device. The processing then moves to step S8.

In step S8, the request confirmation unit 107 determines whether a request for transmission of a video is received from any of the wireless devices 103-1 to 103-n or not. If it is determined in step S8 that a request for transmission of a video has been received, the processing moves to step S9. If it is determined in step S8 that a request for transmission of a video has not been received, the processing returns to step S1.

In step S9, the request confirmation unit 107 determines whether transmission of a high-quality video is requested or not. When it is determined in step S9 that transmission of a high-quality video has been requested, the processing moves to step S10. When it is determined in step S9 that transmission of a high-quality video has not been requested, the processing moves to step S11.

In step S10, the control unit 108 selects a wireless device capable of transmitting a video of higher quality from among the wireless devices 103-1 to 103-n satisfying a condition for a traffic allowance that is notified together with a request for transmission of a video from the base station 20.

In step S11, the control unit 108 selects a wireless device capable of high-speed transmission of a video from among the wireless devices 103-1 to 103-n satisfying the condition for a traffic allowance that is notified together with the request for transmission of a video from the base station 20.

In step S12, the control unit 108 acquires a video from the image storage unit 102. The control unit 108 then transmits the video by using the selected wireless device. Thereafter, processing returns to step S1.

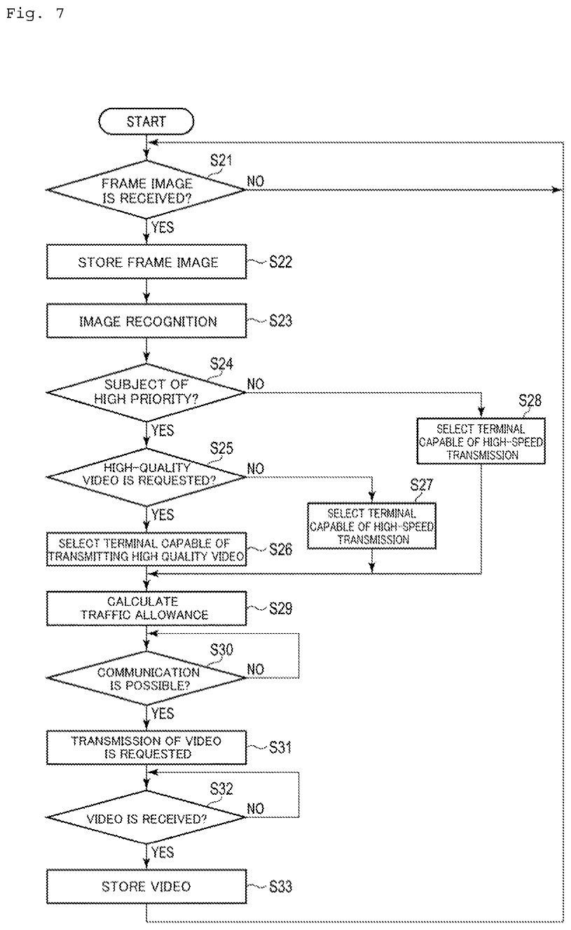

Next, an operation of the base station 20 will be described. FIG. 7 is a flowchart showing the operation of the base station 20. In step S21, the wireless devices 201-1 to 201-n determine whether or not a frame image has been received. If it is determined in step S21 that a frame image has been received, the processing moves to step S22. If it is determined in step S21 that a frame image has not been received, the processing is suspended.

In step S22, the wireless devices 201-1 to 201-n store the received frame image in the image storage unit 202.

In step S23, the image recognition unit 204 acquires the frame image from the image storage unit 202 and recognizes subjects in the frame image.

In step S24, the control unit 206 refers to the information of the priority storage unit 201 and determines whether or not a subject of high priority exists among the subjects recognized by the image recognition unit 204. When it is determined in step S24 that the subject of high plurality exists, the processing moves to step S25. When it is determined in step S24 that the subject of high priority does not exist, the processing moves to step S28.

In step S25, the control unit 206 determines whether it is necessary to request a high-quality video. For example, when the size of a subject photographed in the frame image is smaller than a predetermined size, it is determined that it is necessary to request a high-quality video by taking into consideration, for example, enlargement processing for analysis in the server 30. In addition, it may be determined whether or not it is necessary to request a high-quality video on the basis of an instruction from the server 30. When it is determined in step S25 that it is necessary to request a high-quality video, the processing moves to step S26. If it is determined in step S25 that it is not necessary to request a high-quality video, the processing moves to step S27.

In step S26, the control unit 206 preferentially selects a terminal 10 capable of transmitting a video of higher quality from among terminals capable of photographing a frame image of the same angle of view as the frame image received in step S21 out of the terminals 10-1 to 10-m. When there is a terminal having an untransmitted video, this terminal may be selected preferentially over the other terminals.

In step S27, the control unit 206 preferentially selects a terminal 10 capable of transmitting a video at a higher speed from among terminals capable of photographing a frame image having the same angle of view as the frame image received in the step S21 out of the terminals 10. When there is a terminal having an untransmitted video, this terminal may be selected preferentially over the other terminals.

In step S28, the control unit 206 preferentially selects a terminal 10 capable of transmitting a video at a higher speed among the terminals 10-1 to 10-m. When there is a terminal having an untransmitted video, this terminal may be selected preferentially over the other terminals.

In step S29, the control unit 206 acquires the wireless information on the selected terminal from the wireless information acquisition unit 205. The control unit 206 then calculates a traffic allowance of the selected terminal on the basis of the acquired wireless information.

In step S30, the control unit 206 determines whether or not it is possible to perform communication with the terminal selected within the range of the calculated traffic allowance. When it is determined in step S30 that communication with the terminal selected within the range of the calculated traffic allowance can be performed, the processing moves to a step S31. When it is determined in the step S30 that communication with the terminal selected within the range of the calculated traffic allowance cannot be performed, the processing is suspended until it is determined that the communication can be performed.

In step S31, the control unit 206 requests the selected terminal to transmit a video by using any one of the wireless devices 203-1 to 203-n. As described above, the request for transmission of the video includes a traffic allowance. When it is necessary to request a high-quality video, the control unit 206 also requests the terminal to send a high-quality video. Here, the wireless device used for making the request of transmission of the video may be a wireless device having the highest RSSI among wireless devices with, for example, available channels.

In step S32, the control unit 206 determines whether or not the video has been received. In step S32, the processing is suspended until it is determined that the video is received. When a fixed time elapses without receiving the video, the processing may be terminated. When it is determined in step S32 that the video has been received, the processing moves to step S33.

In step S33, the control unit 206 stores the received video in the image storage unit 202. Thereafter, the processing returns to step S21.

As described above, according to the embodiment, first, a frame image, which is a still image extracted from a video, is transmitted from a terminal to the base station. When it is determined by the base station that it is necessary to transmit the video, the base station requests the terminal to transmit the video. Thus, the transmission capacity is reduced compared with the case where a video is always transmitted. For example, when the wireless system is applied to a bird/animal detection system for bird/animal traps, the priority when the subject is a bird/animal is set higher than the priority when the subject is a person or the like. In this case, a request for transmission of a video is preferentially made to a terminal which has transmitted a frame image in which a subject is a bird/animal. Accordingly, required videos are collected in the base station while reducing the transmission capacity. In this manner, the wireless system of the embodiment is suitable for transmission of a video acquired by an IoT apparatus equipped with a camera or the like.

Also, according to the embodiment, the terminal includes a plurality of wireless devices, that differ in at least communication path, channel, or data compression rate. The terminal selects a wireless device to be used for transmission of a video according to the quality of a video requested by the base station and the wireless environment. Thus, the transmission of a video is stably performed.

According to the embodiment, the base station can communicate with a plurality of terminals. In accordance with the video quality and the wireless environment, the base station selects a terminal for requesting transmission of a video. Thus, the transmission of a video is stably performed. When one camera is connected to a plurality of terminals, a video is transmitted by using a terminal capable of more stable communication.

In the embodiment, a wireless device is selected when a frame image or a video is transmitted from a terminal. On the other hand, only one wireless device may be used. In this case, selection of the wireless device can be omitted. Similarly, there may be only one terminal capable of communicating with the base station. In this case, selection of the terminal can be omitted.

### Modification

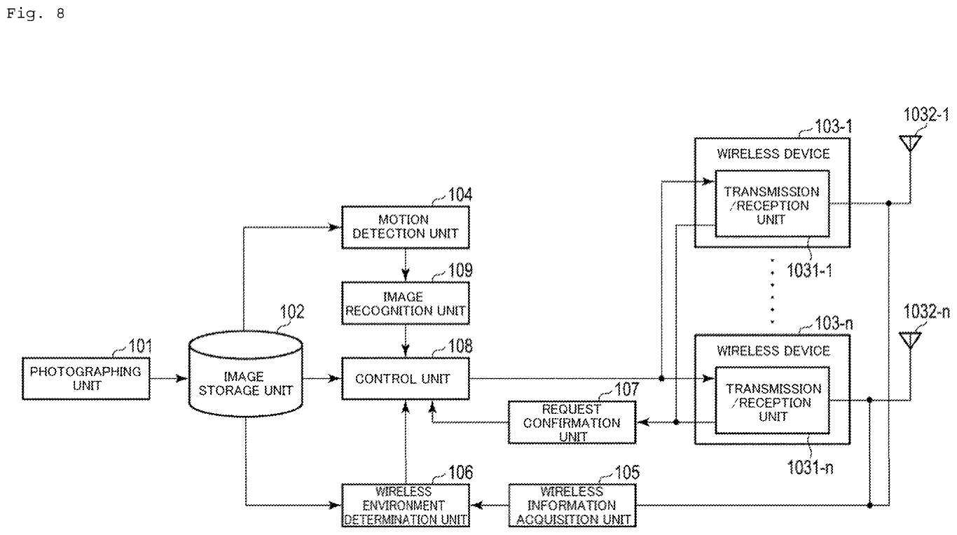

A modification of the embodiment will be described next. In the embodiment, whether to request transmission of a video is determined in the base station. However, the present invention is not limited thereto. FIG. 8 shows an example in which whether to transmit a video or not is determined in the terminal 10. The terminal 10 of a modification includes an image recognition unit 109 in addition to the configuration shown in FIG. 4. The image recognition unit 109 recognizes a subject in a frame image in the same manner as the image recognition unit 204. Then, the control unit 108 of the modification determines to transmit a video when the priority of the subject in the frame image is high, as in the control unit 206.

Since the terminal 10 has the configuration shown in FIG. 8, it is not necessary for the terminal 10 to transmit a frame image to the base station 20. Furthermore, it is not necessary for the base station 20 to determine whether or not to request transmission of a video. That is, the base station 20 does not determine whether to request transmission of a video, buts executes only the selection of the terminal. Therefore, it is not necessary for the base station 20 to have the image recognition unit 204. Needless to say, the base station 20 may have the image recognition unit 204.

Further, the determination of whether or not to request transmission of a video may be performed not in the base station 20 but in the server 30. In this case, the base station 20 selects a terminal in response to a request from the server 30, and requests the selected terminal to transmit a video.

### Other Modifications

Each type of processing in the embodiment described above can also be stored as a program that can be executed by a CPU or the like that is a computer. In addition, the programs can be stored in a storage medium of an external storage device such as a magnetic disk, an optical disk, a semiconductor memory, or the like, and distributed. The CPU or the like can then execute the above-described processing by reading the programs stored in the storage medium of the external storage device, and controlling the operations by the read programs.

Note that the present invention is not limited to the embodiments described above and can variously be modified at an execution stage within a scope not departing from the gist thereof. The embodiments may also be combined appropriately to be implemented, and in such a case, combined effects can be obtained. In addition, the embodiments described above include various inventions, and the various inventions can be extracted by combinations selected from a plurality of disclosed constituent elements. For example, even when some of all of the constituent elements disclosed in the embodiments are deleted, as long as the problems can be solved and the effects can be obtained, a configuration from which the constituent elements are deleted can be extracted as an invention.

### Reference Signs List

1 Wireless system
10, 10-1 to 10-m Terminal
11 CPU
12 ROM
13 RAM
14 Camera
15 Storage
16 Wireless communication module
20 Base station
21 CPU
22 ROM
23 RAM
24 Storage
25 Wireless communication module
26 Wire communication module
30 Server
101 Photographing unit
102 Image storage unit
103-1 to 103-n Wireless device
104 Motion detection unit
105 Wireless information acquisition unit
106 Wireless environment determination unit
107 Request confirmation unit
108 Control unit
109 Image recognition unit
201 Priority storage unit
202 Image storage unit
201-1 to 203-n Wireless devices
204 Image recognition unit
205 Wireless information acquisition unit
206 Control unit
1031-1 to 1031-n Transmission/reception unit
1032-1 to 1032-n Antenna
2031-1 to 2031-n Transmission/reception unit
2032-1 to 2032-n Antenna

1. A wireless system comprising: at least one terminal that includes a wireless communication module configured to transmit and receive data to and from a base station, and a first control unit configured to transmit a frame image, which is a still image extracted from an acquired video, to the base station by using the wireless communication module when motion is detected from the acquired video, and to transmit the video to the base station by using the wireless communication module when transmission of the video is requested from the base station as a result of transmitting the frame image; and the base station that includes a second control unit configured to determine whether to request transmission of the video based on the frame image and to request the terminal to transmit the video when determining to request transmission of the video.

2. The wireless system according to claim 1, wherein the wireless communication module includes a plurality of wireless devices that differ in at least communication path, use channel, or data compression rate, and the first control unit selects a wireless device that transmits the video on a basis of wireless information related to a wireless environment of each of the plurality of wireless devices.

3. The wireless system according to claim 1, wherein the base station transmits and receives data to and from a plurality of the terminals, and the second control unit requests one of the plurality of terminals to transmit the video according to a priority of transmission of a video.

4. The wireless system according to claim 3, wherein the second control unit preferentially requests the terminal that has transmitted the frame image in which the motion is a bird/animal, to transmit the video.

5. A terminal, comprising:
a wireless communication module configured to transmit and receive data to and from a base station;
a processor; and
a storage medium having computer program instructions stored thereon, when executed by the processor, perform to:
determine whether or not to transmit an acquired video when motion is detected from the acquired video, and to transmit the video to the base station by using the wireless communication module when determining to transmit the video.

6. (canceled)

7. A wireless transmission method, comprising: acquiring a video at a terminal; detecting motion from the video; transmitting a frame image, which is a still image extracted from the video, when the motion is detected, from the terminal to the base station; and transmitting the video from the terminal to the base station when transmission of the video is requested from the base station as a result of transmitting the frame image.

8. A non-transitory computer-readable medium having computer-executable instructions that, upon execution of the instructions by a processor of a computer, cause the computer to function as the terminal described in claim 5.
